(19) United States
(12) Patent Application Publication
(10) Pub. No.: US 2012/0096784 A1
(43) Pub. Date: Apr. 26, 2012

(54) Window trim having integrated window box gasket

(76) Inventor: Daniel Cashman, Suffield, CT (US)

(21) Appl. No.: 12/925,463

(22) Filed: Oct. 22, 2010

(51) Int. Cl. E06B 1/36

(52) U.S. Cl. 52/213

(57) ABSTRACT

A window or other trim frame having an opening defined by inside edges of connected frame elements for surrounding a window box or the like having outside edges with a small gap, wherein one of the edges carries a pre-installed gasket for passively sealing the gap and thereby avoiding the need to caulk the gap.

### RELATED APPLICATION

This application claims the benefit under 35 U.S.C. §120, of U.S. patent application Ser. No. 12/152,112 filed May 12, 2008 and published as US 2009/0277110 on Nov. 12, 2009, for “Window Frame With Installation Flange”, and U.S. patent application Ser. No. 12/383,985 filed Mar. 31, 2009 and published as US 2010/0242384 on Sep. 30, 2010 for “Rapid Install Mantle”, the entire disclosures of which are hereby incorporated by reference.

### BACKGROUND

The present invention relates to building construction and in particular to the installation of trim on the building exterior.

Window trim units surrounding a window box in a building wall penetration are shown and described in U.S. Pat. Pub. 2009/0277110. Conventionally, the window box is attached to the building exterior wall around the penetration and defines an outer perimeter for receiving window trim (e.g., window frame). The window box and window frame are structurally attached to the building wall around the penetration, but the interface or gap between them must be sealed from the elements by caulking. This is labor intensive and can be unsightly.

### SUMMARY OF THE INVENTION

In one broad aspect, the invention is directed to a window or other trim frame having an opening defined by an inside perimeter or border, for receiving a window box or other building component having an outer edge, wherein a pre-installed gasket is provided in one of the trim inside border or the component outside edge.

The disclosure is directed to a trim piece such as a window frame affixed to wall around a building component such as a window box affixed to wall, with a gap between them to be sealed from the elements. The gasket has a stem secured in a groove or channel in the window box and a body portion compressed in the gap.

The gasket is preferably seated in a contoured surface where the channel opens to the edge.

In a more particular aspect, the invention is directed to a trim for a window box, comprising a plurality of frame elements connected together to form a closed frame having inner edges defining an opening for receiving a window box, and a gasket on the inner edges of each frame element, for sealingly receiving the window box in the opening.

In another aspect, the invention is directed to a combination of a window trim unit with a window box having a rigid frame supporting at least one glass panel, with the window box surrounded by the inner edges of the window trim and in contact with the gasket.

In yet another aspect, the trim is attached to a border surrounding a penetration in a building wall and the window box is attached to the building at the penetration.

The present invention includes a window trim frame wherein the edges of the inside perimeter of the window have grooves that are specially adapted to receive gasket elements to be inserted by the window frame installer in the field.

Similarly, a kit or the like having a window frame with grooves in combination with pre-cut strips or a roll of gasket material to be trimmed to length and installed in the field, is also within the scope of the present invention.

Conventionally, the inside perimeter is a simple board edge and the window box must be caulked in. The preinstalled gasket avoids the need for caulking and thus saves the installer significant time.

### BRIEF DESCRIPTION OF THE DRAWING

Various embodiments will are described below with reference to the accompanying drawing, in which:

FIG. 1 is an elevation view of a window frame including optional moulding, constituting a trim unit for a window box and showing a gasket at the opening where the window box is to be received;

FIG. 2 is a section view taken along line 2-2 of FIG. 1, with a first embodiment of a gasket;

FIG. 3 is an elevation view of the window frame of FIG. 1, showing a movable portion of the moulding separated from the stationary portion of the moulding, to expose holes for attaching the trim body to the wall;

FIG. 4 is an oblique view of the window frame of FIG. 1 as attached to the wall and receiving siding panels along a peripheral channel;

FIG. 5 is a view similar to FIG. 2, showing a different gasket on a top frame element that does not have moulding, as compressed against the window box;

FIG. 6 shows the preferred type of gasket as used in the embodiment of FIG. 5; and

FIG. 7 shows a generalized relationship between a trim piece such as a window frame and a building component such as a window box, wherein the gasket is carried by the building component.

### DETAILED DESCRIPTION

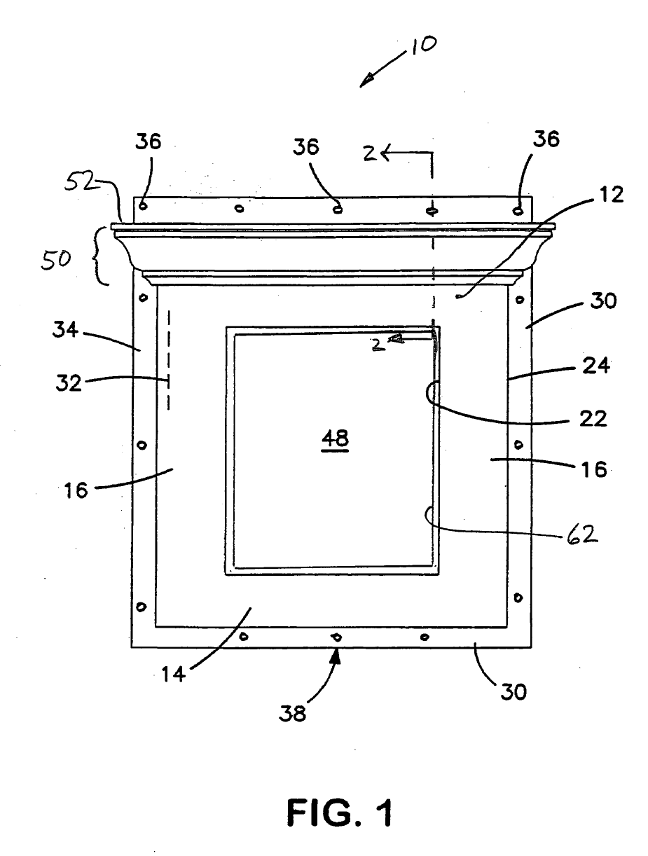

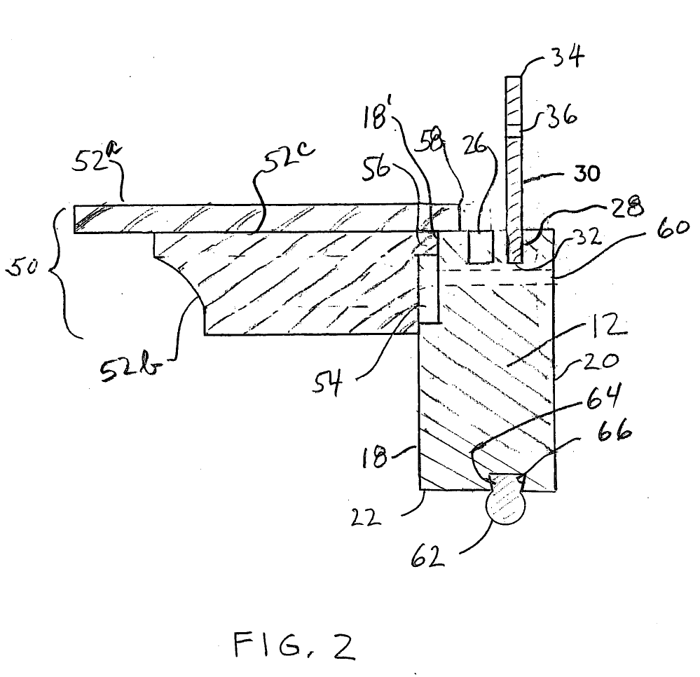

The first embodiment will be described with reference to FIGS. 1-4, which show a prefabricated window frame 10, having top element 12, a bottom element 14 and side elements 16 connected together to define a rectangular frame, each element having front 18 and back faces, and inner 22 and outer 24 edges. At least the side elements 16, but preferably also the top and bottom elements 12, 14 have a channel 28 in which mounting strips 30 have been press fit. Optionally, the edges can also include another channel indicated at 26 in FIG. 2, to facilitate installation of vinyl or aluminum siding against the frame as described in U.S. Publication 2009/0277110. The inner edge 32 of the mounting strip 30 is retained well within the edge 22 of the frame, and the outer edge 34 of the strip extends outside the perimeter of the frame, where mounting holes 36 are provided in the strip.

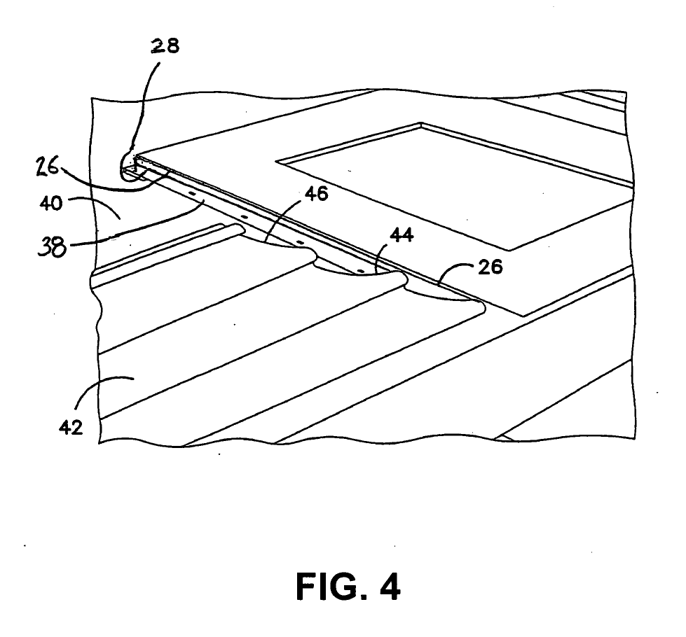

Whether prefabricated as an entire unit or assembled on site as such unit, the frame with strips and/or complete mounting flange 38 are placed around the window box or similar penetration with the back face 20 of the frame against the wall 40, as show in FIG. 4. The flange 38 then is affixed to the wall, such as by nailing through holes 36 to arrive at a condition shown in FIG. 1. To accommodate the subsequent attachment of vinyl or aluminum siding 42 to the wall 40, the longitudinal end seams 44 and end edges 46 of the sliding panels are slid into the channel 26 of each frame element.

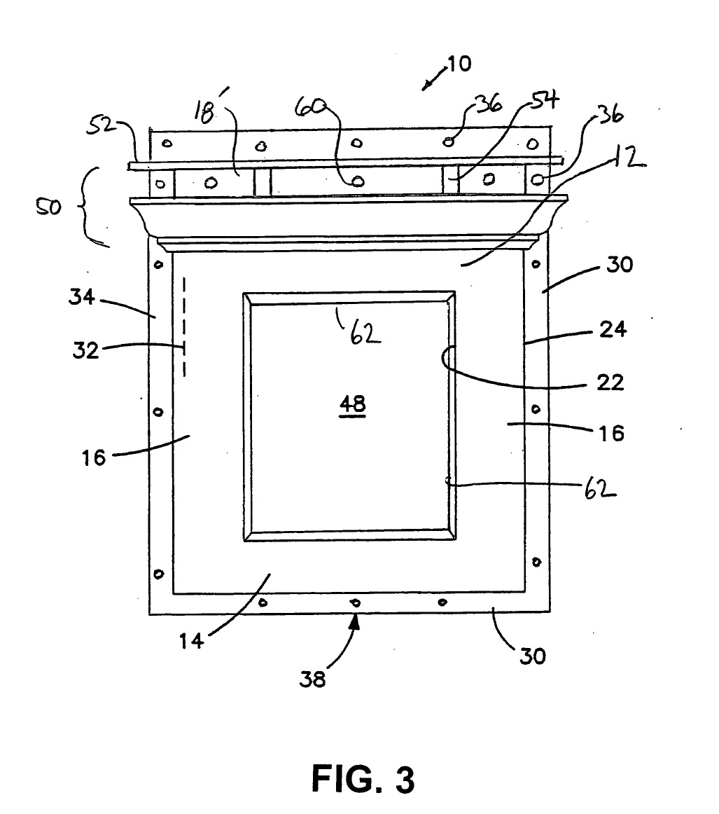

The top frame element 12 (above the window box opening 48) may include a decorative moulding 50, preferably consisting of a top board 52a and a base 52b. The top board 52a is permanently affixed near its inner edge 58, to the top of element 12. While the window frame is attached to the building by the mounting strips 30, the base 52b of the moulding is slid away from the top board 52a, to the position shown in FIG. 3. This is possible because the front 18 of element 12 includes a groove 54 indicated at 18′ engaging a projection 56 in the base portion of the moulding 52b. The preferred dovetail joint 54, 56, permits displacement of the base 52b downwardly below the elevation of the through hole 60, as shown in FIG. 3. The installer can then further secure the frame to the building wall by connecting the rigid top element 12 to the wall with fasteners through hole 60. Preferably, the attachment holes 60 are not in the grooves 54, to avoid any interference between an installation nail or screw and the tongue portion 56 of the slidable moulding base 52b.

After the screws are installed through holes 60, the top surface 52c of the base 52b is glued and the base 52b is slid into contact with the top piece 52b and preferably clamped to complete the installation as shown in FIG. 1.

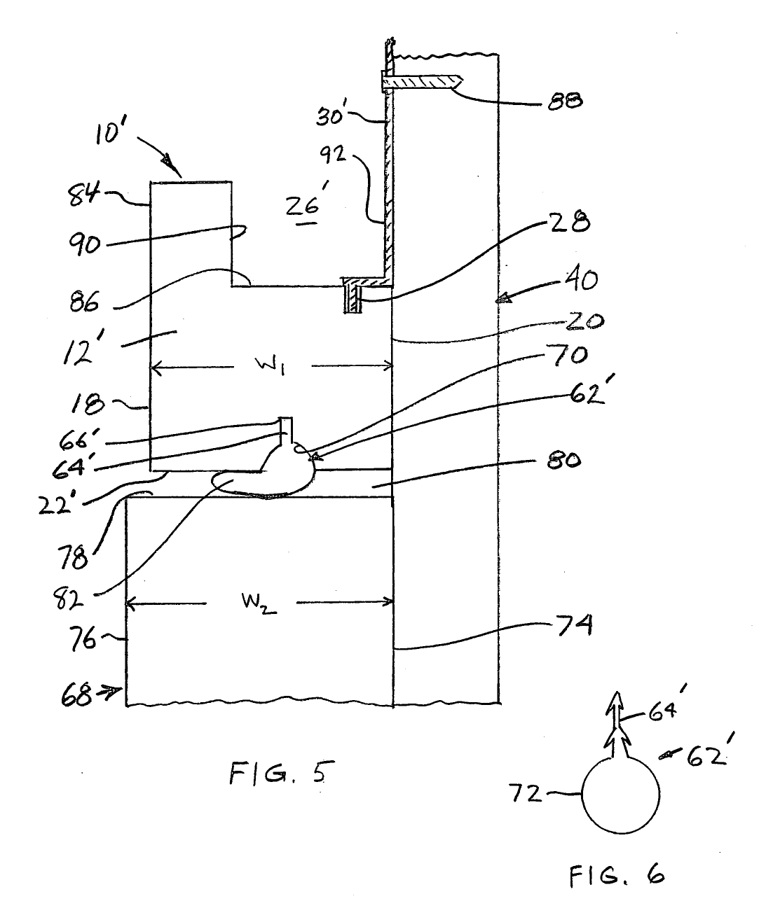

In accordance with aspects of the present invention evident in FIGS. 1-3, 5 and 6, the inside perimeter 22, 22′ of the window frame which defines the opening 48 for receiving the window box 68, includes a pre-installed gasket 62, 62′ which is preferably press fit with inner edge formation such as stem portion 64, 64′ into a corresponding groove or channel formation 66, 66′. (In the numeric identifiers, a prime indicates a variation shown in FIG. 5 relative to FIG. 2, but unless otherwise mentioned, the functional characteristics associated with a given numeral are essentially the same). Channel 66 is preferably closer to back face 20 than to front face 18. In this context, “pre-installed” should be understood as meaning that the gasket is installed in the edges 22 of the window trim opening, before the window frame is applied around the window box 68.

FIGS. 5 and 6 show an embodiment as installed on the wall. The edge 22′ preferably has a semicircular groove or similar contour 70 such that the substantially cylindrical or bulbous compressible body portion 72 of the gasket is partially seated therein. The stem 64′ has a barbed formation which can relatively easily enter a rectangular channel or groove 66′ in the edge 22′ but which cannot easily be removed.

The trim frame 12, 12′ is installed from outside the wall 40, over the previously installed window box 68, which has a back side 74 flush with wall 40. The trim element 12′ would generally have a width W1 from visible front face 18 to back face 20 of about one inch whereas the top element of the window box 68 would generally have a slightly greater width W2 from front 76 to back 74. In the fabrication of the window frame trim unit 10′, the inner edge 22′ of each trim element is dimensioned such that when the trim unit is slide over the (four) outer edges 78 of the window box, a gap 80 is produced at every such outer edge, preferably about ⅛ inch. The bulbous portion 72 of the gasket spans this gap and is deformed as the installer pushes the trim unit along the outer edges 78 of the window box 68. As a result the bulbous portion is squeezed in the gap and will be deformed with a tail or the like as indicated at 82 in FIG. 5. This deformation increases the contact area of the gasket compression between the edges of the gap, and thus provides a very effective seal against water penetration through the gap 80 into the wall 40. This avoids the need for caulking between the trim unit 12 and the window box 68.

It should thus be appreciated that the preinstalled gasket feature can be employed not only with the movable moulding described with respect to FIGS. 1-3, but with any window frame regardless of installation technique onto the building wall. For example, as shown in FIG. 5, the top element 12′ of a frame without top moulding can have a front lip 84 and rearward channel 28 associated with top edge 86. A mounting strip 30′ has one end in channel 28 and is angled such that most of the strip 30′ is flush with wall 40 and affixed thereto with hardware 88. The inside 90 of front lip 84, the lower portion 92 of the mounting strip, and top edge 86 form another channel 26′ for receiving siding panels, equivalent to the channel 26 of FIG. 2. Moreover, in some embodiments the trim unit with gasket need not have a channel for receiving siding panels.

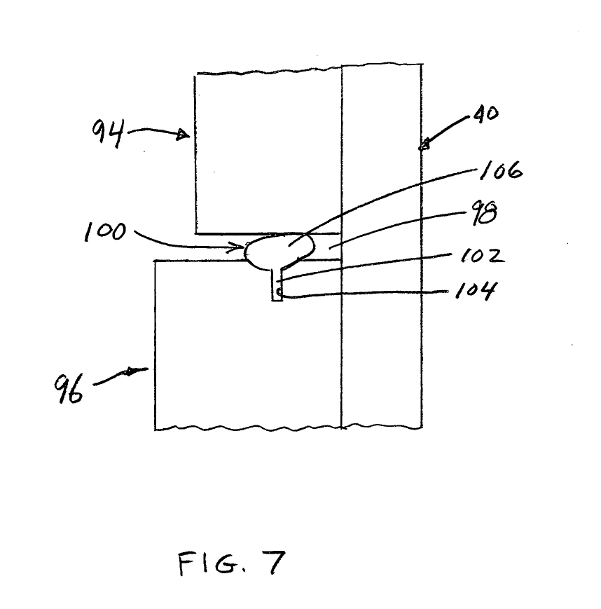

FIG. 7 shows a generalized relationship between a trim piece such as a window frame 94 affixed to wall 40 around a building component such as a window box 96 affixed to wall 40, with a gap 98 between them to be sealed from the elements. In this embodiment, the gasket 100 has a stem 102 secured in groove or channel 104 in the window box and the body portion 106 is compressed in the gap.

Furthermore, whereas the gasket 62 or 100 would generally be pre-installed by the fabricator of the trim or building component, the present invention includes a trim or a component wherein the edges of the inside perimeter or outside perimeter, respectively, have grooves 66, 104 that are specially adapted to receive gasket elements 62, 100 to be inserted by the installer in the field. Similarly, a trim or building component as described above, in combination with a roll of gasket material to be cut to length and installed in the field, is also within the scope of the present invention.

Thus, the trim for a window box, can comprise a plurality of frame elements connected together to form a closed frame having inner edges defining an opening for receiving the window box, wherein each inner edge has a groove or channel for receiving a gasket which will sealingly bear on the outer edges of a window box. The invention includes a kit for assembling a trim for a window box, comprising a plurality of frame elements connected together to form a closed frame having inner edges defining an opening for receiving the window box, wherein each inner edge has a first formation for receiving a gasket which will sealingly bear on the outer edges of a window box. The gasket material has an edge defining a second formation sized for installation on the frame elements by engaging the first formation, and a body for compressively receiving the window box.

In the completed installation of a window box affixed around a wall penetration and a window frame attached to the wall around the window box, the entire outer periphery of the window box (e.g. four rectangular edges) is sealed against gasket material carried on the entire inner edge of the window frame (e.g., four rectangular frame elements). Preferably, the gasket or gaskets are secured in channels that run the full lengths of each edge of the window frame, and likewise the gasket or gaskets have formations that engage the channels over their full lengths. A contoured groove is preferably provided along the length of the channel, where the channel meets the inner edge.

In an alternative configuration of the foregoing, the gasket can be pre-installed at the outer edge of the window box. In this embodiment, a window box is affixed around a building penetration, and a window frame is also affixed to the building such that the inner edge of the frame surrounds the outer edge of the window box, thereby forming a gap between the inner edge of the frame and the outer edge of the window box. A gasket secured in the outer edge of the window box is compressed between the inner edge of the frame and the outer edge of the window box.

1. A trim frame for a window box, comprising: a plurality of frame elements connected together to form a closed frame having inner edges defining an opening for receiving the window box, and a gasket on the inner edges of each frame element, for sealingly receiving the window box in the opening.

2. The trim frame of claim 1, wherein each inner edge has a respective channel and a gasket is secured in each channel.

3. The trim frame of claim 2, wherein the gasket is press fit into each channel.

4. The trim frame of claim 1, wherein
a window box is attached to a building at a wall penetration; and
the trim frame is attached to the building wall around the window box such that the window box is surrounded by the inner edges of the window trim frame whereby the gasket is compressed between the window trim and the window box.

5. The trim frame of claim 4, wherein
each inner edge has a respective channel that runs the full length of each inner edge; and
the gasket engages the channels over the full lengths of each channel.

6. The trim frame of claim 5, wherein the gasket is press fit into the channel.

7. The trim frame of claim 2, wherein the gasket has a barbed stem press fit in said channel and a compressible body outside said channel.

8. The trim frame of claim 7, wherein the edge of the trim element at the channel, has a contour in which a portion of the gasket body is seated.

9. The trim frame of claim 1, wherein
a window box is attached to the building at a wall penetration;
the trim is a window frame attached to the building wall around the window box, such that inner edges of the window frame surround and form a gap with the outer edges of the window box; and
the gasket has a stem portion secured in a first channel in the inner edge of the window frame and a resilient body portion seated in part in a contour at the inner edge of the window frame and compressed between the window frame and the window box.

10. The trim frame of claim 9, wherein
the trim frame has a width between a visible front face and a back face that is flush with the wall;
said channel is closer to the back face than to the front face;
the gasket has a barbed stem friction fit in said channel and a compressible body outside said channel; and
the body portion is deformed with a tail in the gap.

11. The trim frame of claim 10, wherein the gap is about ⅛ inch.

12. The trim frame of claim 4, wherein
the window frame has opposed top and bottom frame elements and opposed side frame elements, each element having front and back faces, an inner edge, and an outer periphery;
each element has a mounting strip attached at the periphery and extending laterally as a flange that is affixed to the wall; and
each element has a siding channel extending along the periphery, having a width effective to receive an edge of a wall siding panel.

13. A trim for a building component, comprising: a plurality of trim elements connected together to form a frame having inner edges defining an inner border for receiving the building component, wherein each inner edge has a channel for receiving a gasket against which the component will be received.

14. The trim of claim 13, wherein the gasket has a stem portion secured in a channel in the inner edge of the frame and a resilient body portion seated in part in a contour at the inner edge of the frame.

15. The trim of claim 13, wherein
the frame has a width between a front face and a back face;
said channel is closer to the back face than to the front face; and
the gasket has a barbed stem friction fit in said channel and a compressible body outside said channel.

16. The trim of claim 13, wherein
the frame has opposed top and bottom frame elements and opposed side frame elements, each element having front and back faces, an inner edge, and an outer periphery;
each element has a mounting strip attached at the periphery and extending laterally as a flange that is affixed to the wall; and
each element has a siding channel extending along the periphery, having a width effective to receive an edge of a wall siding panel.

17. A trim assembly on a building, comprising
a building component affixed to a building and having an outer edge;
a trim frame attached to the building and having an inner edge surrounding the component, whereby a gap is provided between the inner edge of the frame and the outer edge of the component; and
a gasket secured in the edge of one of the frame or component, and compressed between the inner edge of the frame and the outer edge of the component.

18. The trim assembly of claim 17, wherein the gasket is seated in a contoured groove.

19. A kit for assembling a trim with a building component on the wall of a building, comprising in combination:
a building component adapted to be affixed to the wall of a building, and having outer edges defining an outside perimeter;
a trim unit having inner edges defining an inside perimeter sized to be affixed to the wall around the building component, with a gap between the inside perimeter of the trim unit and the outside perimeter of the building component;
wherein one of the inner edges or outer edges of the inner and outer perimeters has a first formation for receiving a gasket; and
gasket material having a second formation sized for installation in the first formation and a resilient body for compressively sealing the gap when the component and trim unit are affixed to the wall.

20. The kit of claim 19, wherein the building component is a window box and the trim unit is a window frame;

21. The kit of claim 20, wherein
the first formation is a channel having a contoured groove;
the gasket has a stem defining the second formation; and
the gasket body is sized to seat in the contoured groove.
